(19) United States
(12) Patent Application Publication
(10) Pub. No.: US 2024/0168800 A1
(43) Pub. Date: May 23, 2024

(54) DYNAMICALLY EXECUTING DATA SOURCE AGNOSTIC DATA PIPELINE CONFIGURATIONS

(71) Applicant: Chime Financial, Inc., San Francisco, CA (US)

(72) Inventors: Karishma Dambe, Fremont, CA (US); Khandu Shinde, Dublin, CA (US); Saurabh Ravindranath Sathaye, Fremont, CA (US); Radhika Tallamraju, Cupertino, CA (US)

(21) Appl. No.: 18/057,874

(22) Filed: Nov. 22, 2022

(51) Int. Cl. G06F 9/48; G06F 9/38; G06F 9/445; G06F 9/54

(52) U.S. Cl. CPC G06F 9/4881; G06F 9/3879; G06F 9/44505; G06F 9/541

(57) ABSTRACT

The disclosure describes embodiments of systems, methods, and non-transitory computer readable storage media that dynamically execute data source agnostic data pipeline job configurations that can interact with a variety of data sources while utilizing a unified request format. In particular, the disclosed systems can facilitate a data pipeline framework that utilizes source connectors for data sources, target connectors for data sources, and data transformations in data pipeline job configurations to build various data pipelines. For instance, the disclosed systems can utilize a data pipeline job configuration that includes requests for a data source in a given language with various other data pipeline functionalities via data source connectors specified within the data pipeline job configuration. For example, the disclosed systems can utilize a data source connector to map data source requests to native code commands for the data source to read or write data in relation to the data source.

### BACKGROUND

Recent years have seen an increasing number of systems that utilize data pipelines between multiple data sources. For instance, many conventional systems utilize data pipelines that facilitate the movement and transformation of data between different data storage sources. Furthermore, many conventional systems facilitate tools that enable the creation and execution of data pipeline job configurations for data pipelines. Although many conventional systems facilitate tools for data pipeline job configurations, such conventional systems often face a number of technical shortcomings. Indeed, conventional systems often utilize rigid and inefficient tools to create and execute data pipeline job configurations across different data sources.

For instance, conventional systems often utilize inflexible data pipeline frameworks. In particular, many conventional systems facilitate data pipeline job configurations that only operate on (or execute for) a particular data source. Accordingly, in many cases, conventional systems often facilitate the creation and utilization of data pipeline job configurations that are not recognized by multiple data sources. Indeed, such conventional systems cannot adapt a working data pipeline job configuration to another data source without extensive modification to the data pipeline job configurations.

Additionally, this lack of adaptivity in conventional data pipeline job configurations often leads to difficulties in creating, managing, and/or utilizing data pipeline job configurations in large systems that may utilize a wide variety of data sources. For example, many conventional systems lack ease of use. In particular, conventional systems often require data pipeline job configuration scripts (or files) that include instructions in the programming language (or application programming interface (API)) used by a particular data source. Such instructions via data source specific languages or APIs require many conventional system tools to require coding of low-level implementations of the data source to connect to the data source, load streams from the data source, and/or execute commands (or requests) on the data source. Accordingly, when such a conventional system interacts with a different data source—or—when the data source changes a recognized language or API, data pipeline job configurations also need to be updated to reflect those changes. As such, many conventional systems require data pipeline job configurations with individually customized instructions for different data sources or different pairings of data sources. This often leads to conventional systems having a wide variety of data pipeline job configurations with different languages or APIs for a variety of data sources or pairings of data sources. Indeed, these conventional systems often facilitate and enable the utilization of data pipeline job configuration tools for highly technical users capable of crafting data pipeline job configurations that are recognized and compatible with individual data sources rather than being user friendly to a wider audience.

Due to the lack of adaptivity and lack of ease of use, many conventional systems also result in inefficient data pipeline job configuration tools. For example, in many conventional systems, commands to data sources within data pipeline job configurations are not repeatable for reoccurring tasks that may involve a different combinations of data sources. Accordingly, conventional systems often require a time intensive amount of modification or creation of data pipeline job configurations through locating commands that are specific to a data source, determining the use or operation of commands, and creating code for the commands to enable a data pipeline job to communicate with and utilize the particular data source. Such a process, in many conventional systems, requires extensive (and inefficient) user interaction and user navigation between multiple tools, development environments, data pipeline configuration files, and development documentations specific to various data sources (e.g., code or API documentations).

### SUMMARY

The disclosure describes one or more embodiments of systems, methods, and non-transitory computer readable media that dynamically execute data source agnostic data pipeline job configurations that can easily, flexibly, and efficiently interact with a variety of data sources having different native code commands while utilizing a unified request format. In particular, the disclosed systems can facilitate a data pipeline framework that utilizes source connectors for data sources, target connectors for data sources, and data transformations in data pipeline job configurations to build various batch and/or streaming data pipelines. For instance, the disclosed systems can utilize a data pipeline job configuration that includes requests for a data source in a given language with various other data pipeline functionalities, such as monitoring, alerting, watermarking, and pipeline job scheduling interchangeably with a variety of data sources via data source connectors specified within the data pipeline job configuration.

In particular, the disclosed systems can identify, within a data pipeline job configuration, an identifier for a data source, requests for the data source, and instructions for other data pipeline functionalities. Upon identifying the data source identifier, the disclosed systems can determine a data source connector to utilize for the data pipeline job configuration. Then, the disclosed system can utilize the data source connector to map the requests for the data source to native code commands for the data source to read or write data in relation to the data source.

### BRIEF DESCRIPTION OF THE DRAWINGS

The detailed description is described with reference to the accompanying drawings in which:

FIG. 1 illustrates a schematic diagram of an environment for implementing an inter-network facilitation system and a data transformation system in accordance with one or more implementations.

FIG. 2 illustrates an overview of a data transformation system executing a data pipeline job configuration with a data source connector in accordance with one or more implementations.

FIG. 3 illustrates an exemplary environment in which a data pipeline job configuration with data source connectors is utilized to move and transform data between data sources in accordance with one or more implementations.

FIG. 4 illustrates a data transformation system utilizing a data pipeline job configuration with data source agnostic requests in accordance with one or more implementations.

FIGS. 5A and 5B illustrate exemplary data pipeline job configurations that include data source identifiers and data source requests in accordance with one or more implementations.

FIG. 6 illustrates a data transformation system monitoring activity and displaying activity of one or more data pipeline jobs in accordance with one or more implementations.

FIG. 7 illustrates a flowchart of series of acts for utilizing a data pipeline job configuration to convert requests to native code commands of a data source to read and/or write data in relation to the data source in accordance with one or more implementations.

FIG. 8 illustrates a block diagram of an exemplary computing device in accordance with one or more implementations.

FIG. 9 illustrates an example environment for an inter-network facilitation system in accordance with one or more implementations.

### DETAILED DESCRIPTION

The disclosure describes one or more embodiments of a data transformation system that enables dynamic utilization of a unified request format within a data source agnostic data pipeline job configuration that can easily, flexibly, and efficiently interact with a variety of data sources having different (or dissimilar) native code commands. Specifically, the data transformation system can identify an identifier for a data source and requests for the data source from a data pipeline job configuration. Moreover, the data transformation system can utilize the data source identifier to select a data source connector. In one or more implementations, the data transformation system utilizes the data source connector to map (or convert) the requests for the data source (from the data pipeline job configuration) to native code commands of the data source. Indeed, then, the data transformation system can utilize the native code commands with the data source to execute the requests identified in the data pipeline job configuration. For example, the data transformation system can read or write data in relation to the data source to accomplish the functionalities of the data pipeline job configuration.

In one or more embodiments, the data transformation system utilizes data pipeline job configurations to execute various functionalities of a data pipeline in relation to one or more data sources. For example, a data pipeline job configuration (e.g., a declarative language script, a set of selected graphical user interface options) can include requests for a data source (e.g., an online and/or offline data storage service) and other instructions to transform data received from (or prior to storing on) the data source. To interchangeably utilize the data pipeline job configuration with a variety of data sources, the data transformation system identifies a data source identifier within the data pipeline job configuration (e.g., a text-based or user selected indication of a particular data source) and one or more requests (or instructions) for the data source.

Upon identifying the data source identifier, the data transformation system selects a data source connector from a set of data source connectors that corresponds to the data source indicated by the data source identifier. In one or more implementations, the data transformation system utilizes the selected data source connector to map (or convert) the requests (from the data pipeline job configuration) to native code commands for the data source (i.e., instructions or requests in a language that is compatible or recognized by the data source). Indeed, in one or more embodiments, the data transformation system can utilize interchange the data source with an additional data source when the data pipeline job configuration indicates a data source identifier for the additional data source by mapping the requests to native code commands for the additional data source.

Subsequently, the data transformation system can utilize the determined native code commands for the data source to execute the requests from the data pipeline job configuration with the data source. As an example, the data transformation system can utilize the determined native code commands to access and/or read data from the data source. In some embodiments, the data transformation system can utilize the determined native code commands to write and/or modify data on the data source. Indeed, in addition to or as part of reading and writing data, the data transformation system can execute various other requests via the data source connector, such as, but not limited to, establishing connections with the data source, connecting to drivers for the data source, connecting to APIs, accessing and/or loading data streams from the data source, and/or requesting statuses from the data source. Furthermore, in addition to the requests to the data source, the data transformation system can, via the data pipeline job configuration, transform data of the data source (e.g., organizing, appending, aggregating, data smoothing, normalization), analyze the data of the data source (e.g., statistical analysis, machine learning analysis, generating reports), and/or implement other functionalities of the data pipeline (e.g., watermarking, monitoring, alerting, scheduling).

The data transformation system can provide numerous technical advantages, benefits, and practical applications relative to conventional systems. To illustrate, unlike conventional systems that are inflexible in adapting to a diverse set of data sources, the data transformation system can facilitate the creation and utilization of data pipeline job configurations that are adaptable to a wide variety of data sources. In particular, the data transformation system can, through utilization of data source connectors to map requests from a data pipeline job configuration to native code commands of a data source, enable the utilization of a unified language and unified data pipeline features and functions across a wide variety of data sources. In some cases, the data transformation system also facilitates code parity between different types of data pipelines (e.g., real-time and/or batch processing pipelines) by enabling unified languages, data pipeline features, and data pipeline features through the utilization of the data source connectors.

In addition to increased adaptivity and flexibility, the data transformation system also improves the ease of use of data pipeline job configuration tools. For example, the data transformation system can utilize data pipeline job configurations without low level implementation code of a data source. Furthermore, unlike many conventional systems, the data transformation system also enables a user to utilize data pipeline job configurations to configure requests to a data source without including API (or other native code commands) of the data source within the data pipeline job configuration. To illustrate, unlike many conventional systems that require extensive modification to data pipeline job configurations when utilize the data pipeline job configurations with different data sources or different pairings of data sources, the data transformation system can enable the data pipeline job configuration to simply receive a change of data source identifiers (and, in some cases, updated database table and/or column names and other namespaces) without changing the format of the requests or instructions (for other functions) in the data pipeline job configuration to execute the requests (and pipeline functions) on a different data source or different combination of data sources. Indeed, the data transformation system enables utilization of data pipeline job configuration tools to a wider user audience (due to improvement in ease of use) rather than being limited to highly technical data pipeline users.

The improvements in adaptivity and ease of use also improve the efficiency of data pipelines and data pipeline job configurations. In particular, the data transformation system enables the creation of data pipeline job configurations that are repeatable for reoccurring tasks that may involve different combinations of data sources. In contrast to many conventional systems that require a time intensive modifications or creation of data pipeline job configurations, the data transformation system enables data pipeline job configurations to execute requests on data sources without code (or programming language) that is specific to the data sources and simply by changing data source identifiers—as described above. Accordingly, the data transformation system enables the utilization of data pipeline job configurations and other data pipeline functionalities with a wider variety of data sources with less user interaction and/or less user navigation (e.g., to reduce screen time of a user, to reduce computational resources and time of operation on data pipeline configuration tools).

As indicated by the foregoing discussion, the present disclosure utilizes a variety of terms to describe features and advantages of the data transformation system. As used herein, the term “data pipeline” refers to a collection of services, tools, processes, and/or data sources that facilitate the movement and/or transformation of data between data sources. As an example, a data pipeline can include various combinations of elements to receive or access data from a data source, transform and/or analyze the data, and/or store the data to a data repository. In some cases, the data transformation system can utilize data pipelines, such as, but not limited to, real-time data pipelines, batch pipelines, extract, transform, load (ETL) pipelines, big data pipelines, and/or extract, load, transform (ELT) pipelines.

As further used herein, the term “data pipeline job” refers to a set of instructions to execute a collection of services, tools, processes, and/or data sources that facilitate the movement and/or transformation of data between data sources. For example, a data pipeline job can include, but is not limited to, instructions to move or transform data (e.g., via read and/or write functions), monitor data, create alerts based on data, create logs or other timestamps for data (e.g., watermarking, logging). In some implementations, the data transformation system can also utilize data pipeline jobs with job schedules (e.g., triggers to run or execute a data pipeline job based on a frequency or time specified through the job schedule).

Moreover, as used herein, the term “data pipeline job configuration” refers to a file, object, and/or a collection of data that represents instructions to execute a data pipeline job. In one or more embodiments, a data pipeline job configuration includes a set of machine-readable instructions that implement various functionalities of a data pipeline. For example, a data pipeline job configuration can include a set of instructions for a data pipeline job represented in a programming paradigm (e.g., a declarative programming language, a script, an object-oriented programming language). In some embodiments, the data pipeline job configuration can include a set of selected options from a graphical user interface for building and/or configuring data pipeline jobs (e.g., selectable options for databases, types of requests, data source identifiers, tags, roles). Indeed, a data pipeline job configuration can include various information, such as, but not limited to data source identifiers, data source type, requests for a data source, roles, permissions, and/or instructions for other functionalities of a data pipeline.

As further used herein, the term “data source” refers to a service or repository (e.g., via hardware and/or software) that manages data (e.g., storage of data, access to data, collection of data). In some cases, a data source refers to a data service or data repository (e.g., via hardware and/or software) that manages data storage via cloud-based services and/or other networks (e.g., offline data stores, online data stores). To illustrate, a data source can include, but is not limited to, cloud computing-based data storage and/or local storage. In some cases, a data source can correspond to various cloud-based data service companies that facilitate the storage, movement, and access to data.

As used herein, the term “native code command” refers to an instruction represented in a programming paradigm (e.g., a declarative programming language, a script, an object-oriented programming language, query language) or other format that is recognized or compatible with a particular data source (or a computer network of the data source). In particular, the term “native code command” refers to an instruction (e.g., for a request in a data pipeline job configuration) through a programming language that adheres to and is recognized by a particular data source to cause the data source to perform a given action. In some cases, a native code command can include instructions in an API for the data source and/or a programming language utilized by the data source. For example, the data transformation system 106 can utilize programming paradigms, such as, but not limited to, SQL, YAML, extensible application markup language (XAML), Python, MySQL, Java, JavaScript, and/or JSON.

In addition, as used herein, the term “data source request” (or sometimes referred to as “request”) refers to an instruction for a data source. In some cases, a data source request can include instructions (or queries) to read from (and/or access) a data source (e.g., select data, export data), create a matrix, write data to a data source (e.g., update data, delete data, insert into data, create database, create table, upload data), update and/or add permissions for the data source, and/or update and/or add settings for the data source. Indeed, the data transformation system can receive data source requests as a set of instructions for a data pipeline job represented in a programming paradigm (as described above).

As used herein, the term “connector” (or sometimes referred to as a “data source connector”) refers to a set of processes that map instructions (e.g., requests) from a data pipeline job configuration to native code commands of a data source. In particular, a connector can include a set of processes that interprets data source requests from a data pipeline job configuration to generate native code commands that cause a data source to execute the data source requests. In some cases, the connector interprets the type of file of the data pipeline job configuration, parses the files, and utilizes the parsed language from the data pipeline job configuration to generate native code commands that are recognized (or compatible) by a given data source.

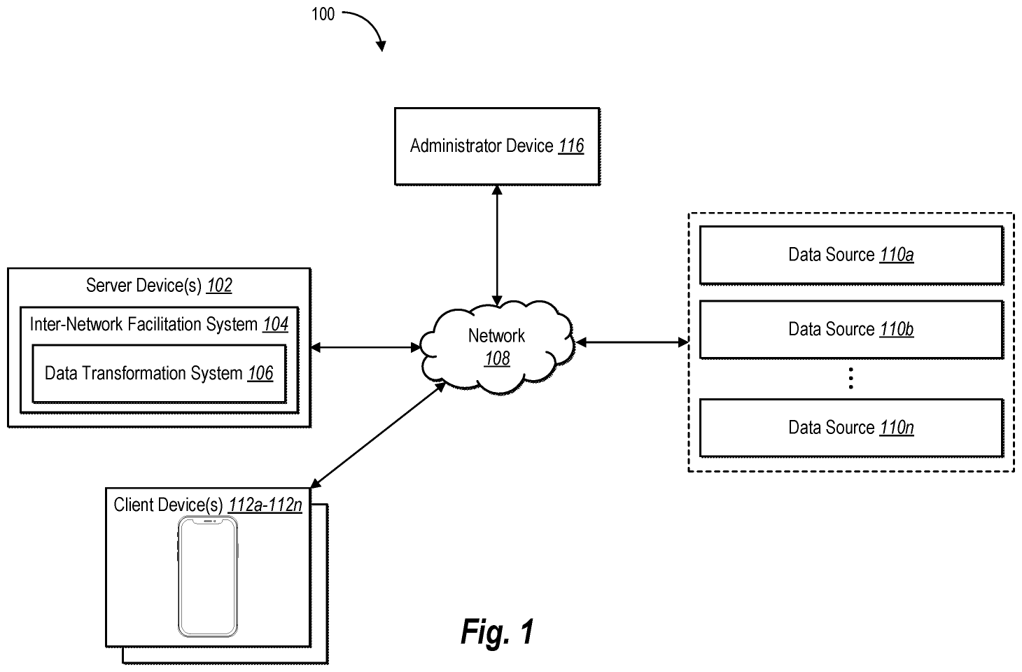

Turning now to the figures, FIG. 1 illustrates a block diagram of a system 100 (or system environment) for implementing an inter-network facilitation system 104 and a data transformation system 106 in accordance with one or more embodiments. As shown in FIG. 1, the system 100 includes server device(s) 102 (which includes the inter-network facilitation system 104 and the data transformation system 106), data sources 110a-110n, client device(s) 112a-112n, and an administrator device 116. As further illustrated in FIG. 1, the server device(s) 102, the data sources 110a-110n, the client device(s) 112a-112n, and the administrator device 116 can communicate via the network 108.

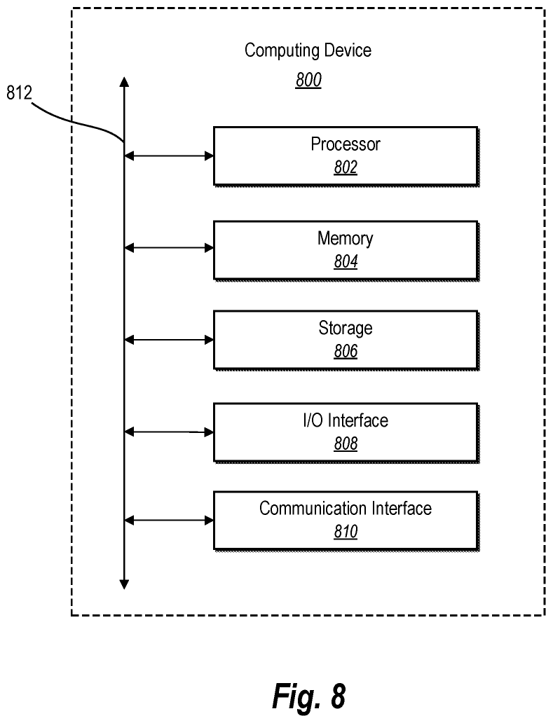

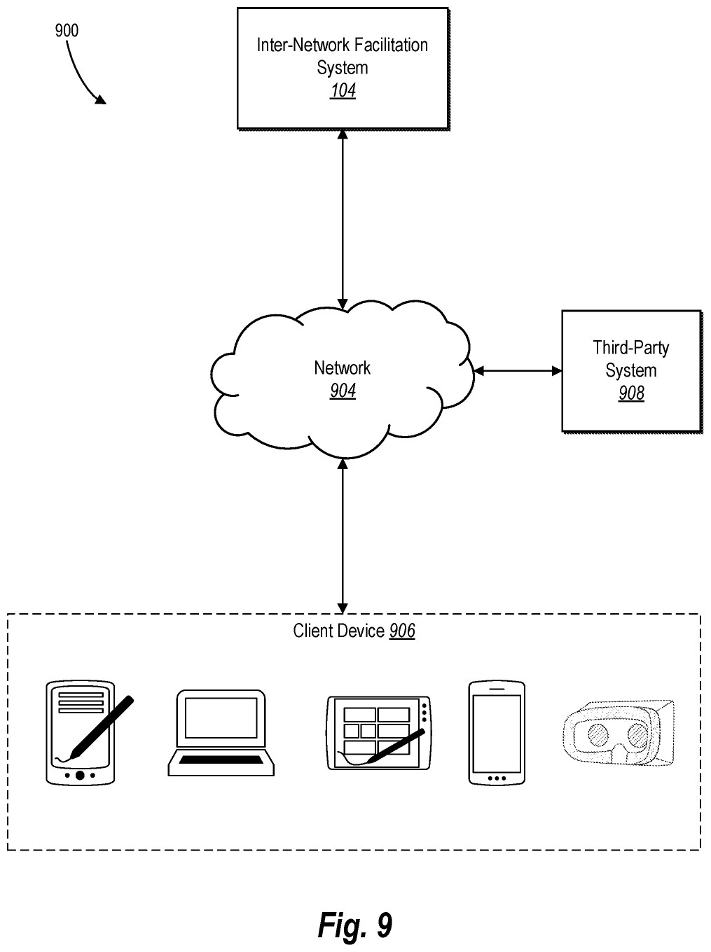

Although FIG. 1 illustrates the data transformation system 106 being implemented by a particular component and/or device within the system 100, the data transformation system 106 can be implemented, in whole or in part, by other computing devices and/or components in the system 100 (e.g., the client device(s) 112a-112n). Additional description regarding the illustrated computing devices (e.g., the server device(s) 102, computing devices implementing the data transformation system 106, the data sources 110a-110n, the client device(s) 112a-112n, the administrator device 116, and/or the network 108) is provided with respect to FIGS. 8 and 9 below.

As shown in FIG. 1, the server device(s) 102 can include the inter-network facilitation system 104. In some embodiments, the inter-network facilitation system 104 can determine, store, generate, and/or display financial information corresponding to a user account (e.g., a banking application, a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the data transformation system 106 and that facilitates financial transactions and digital communications across different computing systems over one or more networks. For example, an inter-network facilitation system manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

In one or more embodiments, the data transformation system 106 enables dynamic utilization of a unified request format within a data pipeline job configuration that can interact with a variety of data sources (e.g., data sources 110a-110n) having different (or dissimilar) native code commands. For instance, the data transformation system 106 can receive a data pipeline job configuration from the administrator device 116. Then, the data transformation system 106 can utilize data source connectors selected based on data source identifiers in the data pipeline job configuration to read and/or write data in relation to the data sources 110a-110n (in accordance with one or more embodiments herein).

Furthermore, as shown in FIG. 1, the system 100 includes the data sources 110a-110n. For example, the data sources 110a-110n can manage and/or store various data for the inter-network facilitation system 104, the client device(s) 112a-112n, and/or the administrator device 116. As mentioned above, the data sources 110a-110n can include various data services or data repositories (e.g., via hardware and/or software) that manage data storage via cloud-based services and/or other networks (e.g., offline data stores, online data stores).

As also illustrated in FIG. 1, the system 100 includes the client device(s) 112a-112n. For example, the client device(s) 112a-112n may include, but are not limited to, mobile devices (e.g., smartphones, tablets) or other type of computing devices, including those explained below with reference to FIGS. 8 and 9. Additionally, the client device(s) 112a-112n can include computing devices associated with (and/or operated by) user accounts for the inter-network facilitation system 104. Moreover, the system 100 can include various numbers of client devices that communicate and/or interact with the inter-network facilitation system 104 and/or the data transformation system 106.

Furthermore, the client device(s) 112a-112n can include the client application(s). The client application(s) can include instructions that (upon execution) cause the client device(s) 112a-112n to perform various actions. For example, a user of a user account can interact with the client application(s) on the client device(s) 112a-112n to access financial information, initiate a financial transaction (e.g., transfer money to another account, deposit money, withdraw money), and/or access or provide data (to the data sources 110a-110n or the server device(s) 102).

In certain instances, the client device(s) 112a-112n corresponds to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of the inter-network facilitation system 104.

Additionally, as shown in FIG. 1, the system 100 also includes the administrator device 116. In certain instances, the administrator device 116 may include, but is not limited to, a mobile device (e.g., smartphone, tablet) or other type of computing device, including those explained below with reference to FIGS. 8 and 9. Additionally, the administrator device 116 can include a computing device associated with (and/or operated by) an administrator for the inter-network facilitation system 104. Moreover, the system 100 can include various numbers of administrator devices that communicate and/or interact with the inter-network facilitation system 104 and/or the data transformation system 106. Indeed, the administrator device 116 can access data generated (or transformed) by one or more data pipelines running on the data transformation system 106 and/or data of the data sources 110a-110n. Furthermore, the administrator device 116 can create, modify, receive, upload, provide, and/or configure various data pipeline job configurations for the data transformation system 106.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 9. Furthermore, although FIG. 1 illustrates the server device(s) 102, the client devices 112a-112n, the data sources 110a-110n, and the administrator device 116 communicating via the network 108, the various components of the system 100 can communicate and/or interact via other methods (e.g., the server device(s) 102 and the client devices 110a-110n can communicate directly).

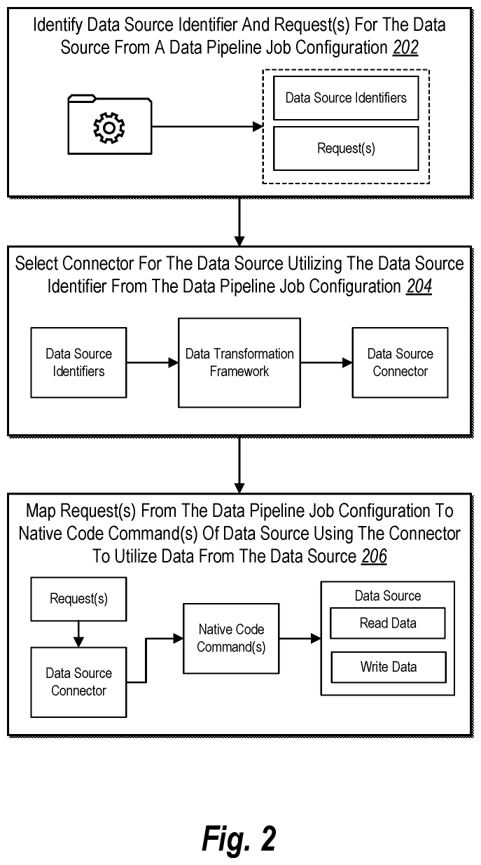

As mentioned above, the data transformation system 106 can execute data pipeline job configurations that can interact with a variety of data sources having different native code commands while utilizing a unified request format. For example, FIG. 2 illustrates an overview of the data transformation system 106 executing a data pipeline job configuration with a data source connector. In particular, as shown in FIG. 2, the data transformation system 106 can identify a data source identifier and requests from a data pipeline job configuration, select a data source connector for the data source identifier, and utilize the data source connector to map requests from the data pipeline job configuration to native code commands of the data source (to read data from or write data to the data source).

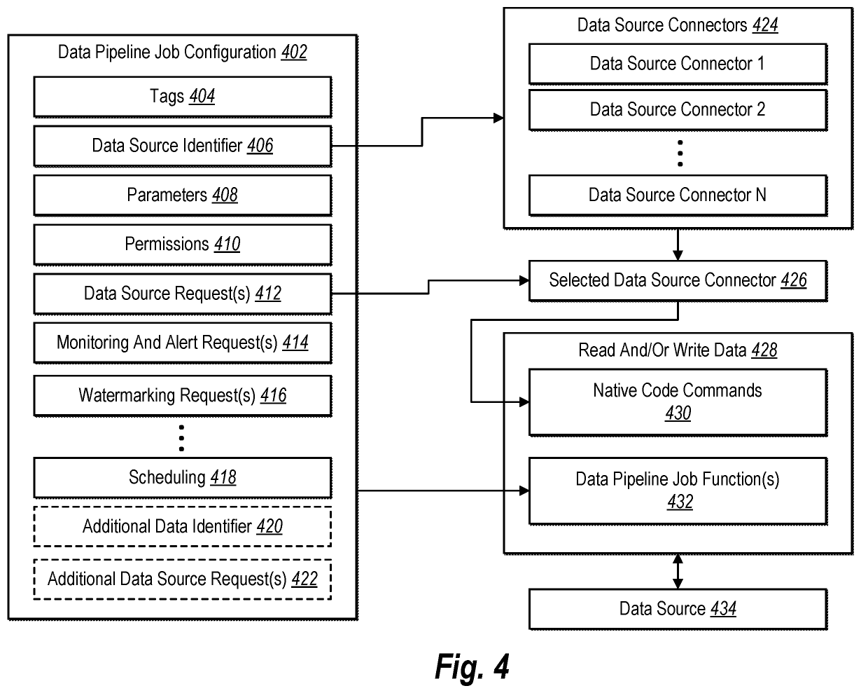

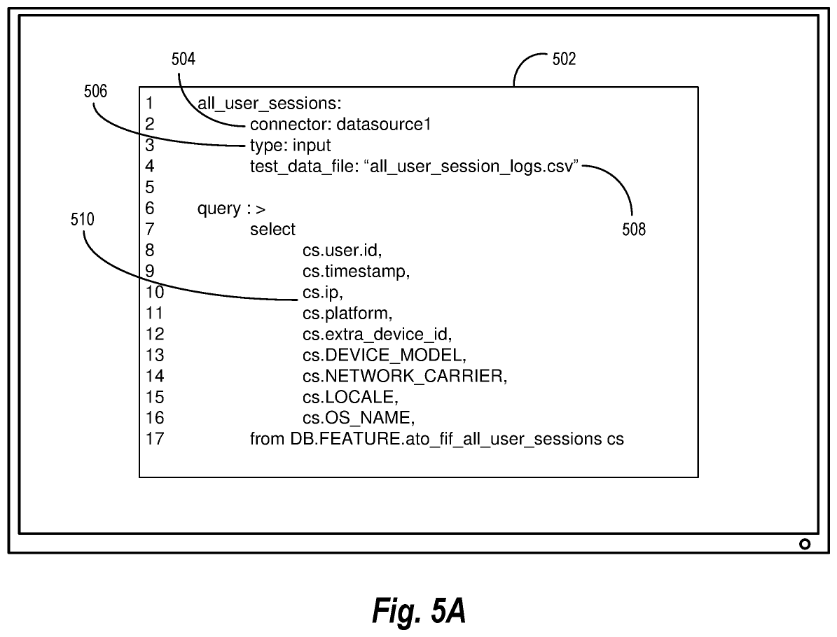

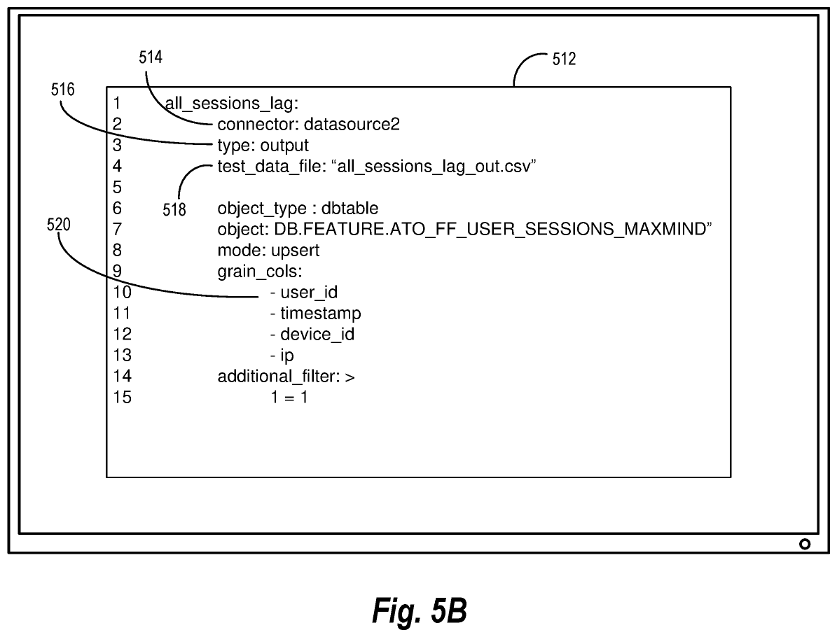

As shown in act 202 of FIG. 2, the data transformation system 106 identifies a data source identifier and request(s) for the data source from a data pipeline job configuration. In particular, the data transformation system 106 can identify, from a data pipeline job configuration that includes declarative language, a data source identifier and one or more requests for the data source. Indeed, the data transformation system 106 can identify data source identifiers and/or requests from a data pipeline job configuration as described below (e.g., in relation to FIGS. 4, 5A, and 5B).

Furthermore, as shown in act 204 of FIG. 2, the data transformation system 106 selects a connector for the data source utilize the data source identifier from the data pipeline job configuration. In particular, the data transformation system 106 (via a data transformation framework) identifies a data source connector, from a set of data source connectors, that corresponds to the data source identifier from the data pipeline job configuration. Indeed, the data transformation system 106 can utilize a data source identifier to select a data source connector as describe below (e.g., in relation to FIG. 4).

Furthermore, as shown in act 206 of FIG. 2, the data transformation system 106 maps request(s) from the data pipeline job configuration to native code command(s) of the data source using the connector to utilize data from the data source. In particular, as shown in the act 206, the data transformation system 106 utilizes the request(s) with the data source connector to convert (or map) the request(s) to native code command(s) that are recognizable by a data source. Then, the data transformation system 106 utilizes the native code command(s) to read data from or write data on the data source. Indeed, the data transformation system 106 can map requests to native code commands and execute the native code commands on a data source as described below (e.g., in relation to FIG. 4).

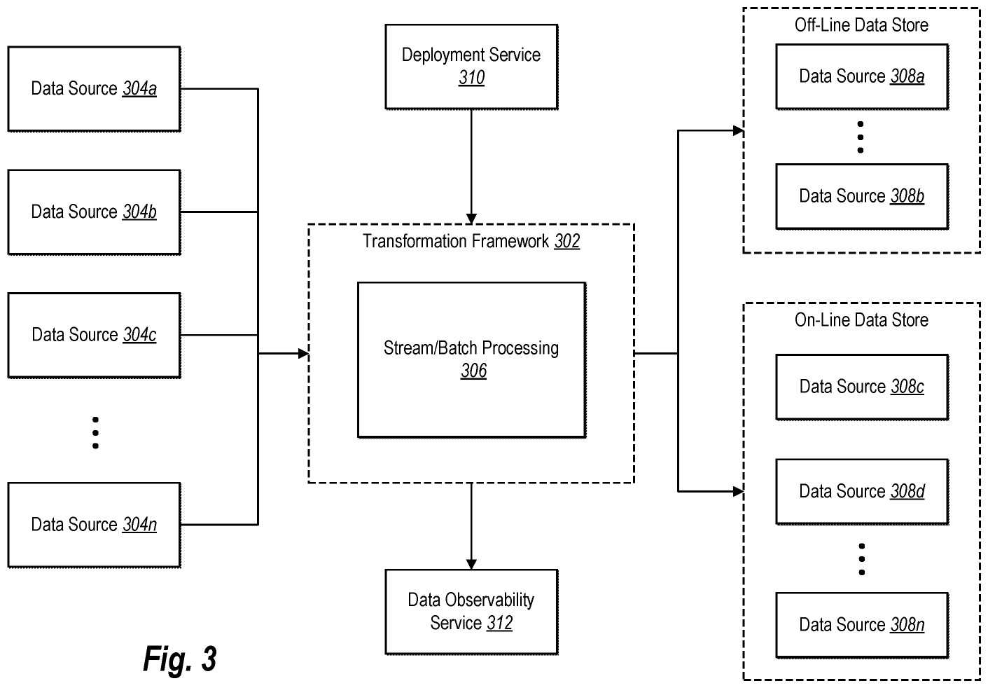

Additionally, FIG. 3 illustrates an exemplary environment in which a data pipeline job configuration with data source connectors is utilized to move and transform data between data sources. As shown in FIG. 3, the data transformation system 106 via a transformation framework 302 can execute a data pipeline job that requests input data from one or more data sources 304a-304n using one or more data connectors with input requests from the data pipeline job configuration. In addition, the data transformation system 106, during stream/patch processing 306 can transform the data from the data sources 304a-304n (e.g., modify, analyze, and/or perform one or more other data pipeline functions on the data). Furthermore, in reference to FIG. 3, the data transformation system 106 can output (or store) the transformed data to one or more of the data sources 308a-308n by using one or more data connectors with output requests from the data pipeline job configuration. As shown in FIG. 3, the data transformation system 106 can utilize both off-line data sources (data stores) and on-line data sources (data stores).

In some embodiments, as shown in FIG. 3, the data transformation system 106 utilizes a deployment service 310. In one or more embodiments, the data transformation system 106 utilizes the deployment service 310 to deploy and/or merge (e.g., a pull request) a data pipeline job configuration into the transformation framework 302 to implement the data pipeline job configuration as an operating data pipeline job. In some cases, the data transformation system 106 utilizes the deployment service 310 to deploy and/or merge a data pipeline job configuration into a repository of data pipeline job configurations. In one or more embodiments, the data transformation system 106 can utilize a locally implemented deployment service and/or a third-party deployment service.

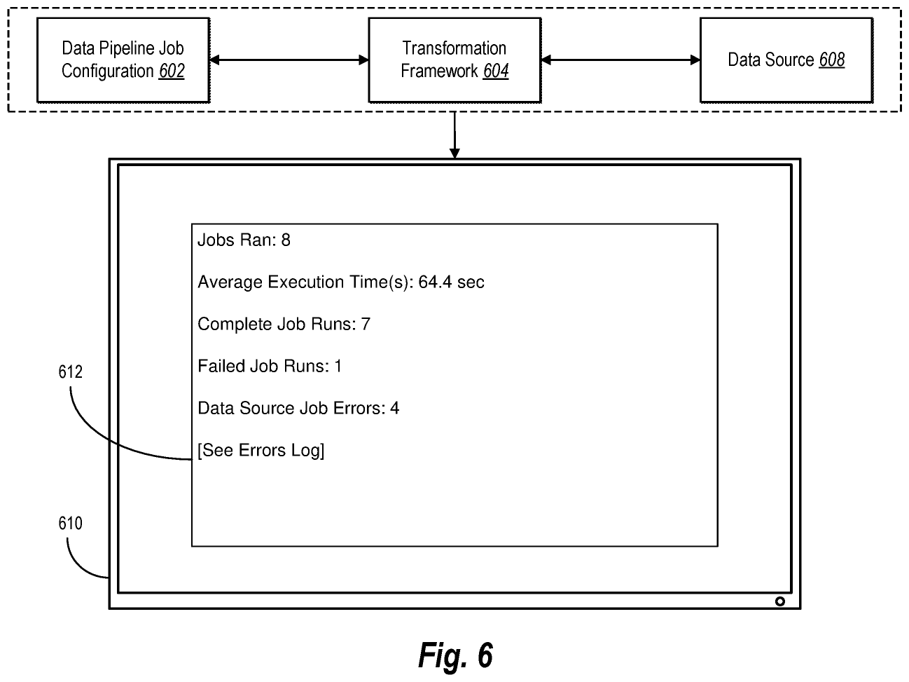

Furthermore, as also shown in FIG. 3, in some cases, the data transformation system 106 utilizes a data observability service 312. In some implementations, the data transformation system 106 utilizes the data observability service 312 to monitor data during the movement and transformation of from the data sources 304a-304n to the data sources 308a-308n utilizing data pipeline job configurations (as described herein). In some cases, the data transformation system 106 utilizes the data observability service 312 to monitor an execution of a data pipeline job (e.g., job runs, execution time, completed job runs, failed job runs, max loaded data) as described below (e.g., in relation to FIG. 6). In some cases, the data transformation system 106 can utilize the data observability service 312 to generate and/or transmit alerts from data movement, data transformation, and/or events that occur during execution of a data pipeline job. In one or more embodiments, the data transformation system 106 can utilize a locally implemented data observability service and/or a third-party data observability service.

As mentioned above, the data transformation system 106 (e.g., as part of the transformation framework 302) utilizes data source identifiers from data pipeline job configurations to determine and utilize data source connectors to map data source requests to native code commands for a data source. For example, FIG. 4 illustrates the data transformation system 106 utilizing a data pipeline job configuration with data source agnostic requests. In particular, FIG. 4 illustrates the data transformation system 106 utilizing a data pipeline job configuration utilized with a particular data source via data source identifier and a data source connector to execute requests from the data pipeline job configuration with the particular data source.

For example, as shown in FIG. 4, the data transformation system 106 can receive a data pipeline job configuration 402. As shown in FIG. 4, the data pipeline job configuration 402 includes tags 404, a data source identifier 406, parameters 408, permissions 410, data source request(s) 412, and one or more additional data pipeline job function(s) (e.g., monitoring and alert request(s) 414, watermarking request(s) 416, scheduling 418). From the data pipeline job configuration 402, the data transformation system 106 can identify a data source identifier 406. As further shown in FIG. 4, the data transformation system 106 can utilize the data source identifier 406 to select a data source connector 426 from a set of data source connectors 424 (e.g., data source connector 1 through data source connector N).

Moreover, as shown in FIG. 4, the data transformation system 106 can also identify one or more data source request(s) 412 from the data pipeline job configuration 402. Additionally, as illustrated in FIG. 4, the data transformation system 106 can utilize the one or more data source request(s) 412 with the selected data source connector 426 to generate native code commands 430 for the data source. Then, as shown in act 428 of FIG. 4, the data transformation system 106 can utilize the native code commands 430 (and the other data pipeline function(s) 432) to read and/or write data in relation to the data source 434 (e.g., the data source corresponding to the data source identifier) to perform the data source request(s) 412.

As previously mentioned, the data transformation system 106 can receive or identify (from a data pipeline job configuration) data source requests that represent instructions for a data source in a programming paradigm. For instance, in some cases, the data transformation system 106 can identify data source requests that are represented as database queries (e.g., in a database programming language). In particular, the data source requests can include database queries that provide commands, such as, but not limited to, select data, provide data, update data, delete data, insert into data, create a database, create a table, upload data, update and/or add permissions for the data source, and/or update and/or add settings for the data source. In one or more embodiments, the data transformation system 106 can utilize multiple data pipeline job configurations having data source request(s) in a unified (e.g., the same) language in the inter-network facilitation system 104 regardless of the data source utilized and the programming language recognized by the data source (e.g., via the data source connectors and data source identifiers).

In some cases, the data transformation system 106 can identify data source requests that are represented as graphical user interface (GUI) selectable options. Indeed, in one or more embodiments, the data transformation system 106 can receive one or more GUI selectable options to create a data pipeline job configuration. For example, the data transformation system 106 can provide, for display within a GUI of an administrator device, one or more selectable options to select data source identifiers and one or more requests for the data source. Indeed, the selectable options can include GUI elements, such as, but not limited to, drop down lists, radio buttons, text input boxes, check boxes, toggles, data pickers, and/or buttons to select one or more data source requests and/or data source identifiers. For example, the data transformation system 106 can identify, from a data pipeline job configuration, user selections of GUI selectable options to indicate a data source identifier and requests to select particular data from a data source.

Additionally, in one or more embodiments, the data transformation system 106 utilizes data source connectors to utilize the data source requests identified from the data pipeline job configuration with a data source. For example, the data transformation system 106 can utilize a set of processes and/or rules that map (or convert) requests in a first programming language (or paradigm) and/or selected GUI options to native code commands for a data source. For example, the data transformation system 106 can utilize a data source connector to parse the data source requests (or identify selected GUI options) in a data pipeline job configuration. Then, the data transformation system 106 can utilize the data source connector to map the parsed requests to native code commands that are recognized and/or compatible with a particular data source. Indeed, the data transformation system 106 can utilize the connector to generate a set of native code commands (e.g., as an executable file) for the data source from the data source requests.

In one or more embodiments, upon generating a set of native code commands for the data source, the data transformation system 106 can utilize the set of native code commands with the particular data source to cause the data source to execute the data source requests from the data pipeline job configuration. Indeed, in one or more embodiments, the data transformation system 106 utilizes the native code commands with the data source to read and/or write data on the data source. For example, the data transformation system 106 can cause the data source (e.g., the data source 434) to execute commands to read and/or write data by performing actions, such as, but not limited to, selecting data, providing data, updating data, deleting data, inserting into data, creating a database, creating a table, uploading data, updating and/or adding permissions for the data source, updating and/or adding settings for the data source using the native code commands that represent the data source requests in the data pipeline job configuration.

In some implementations, the data transformation system 106 also identifies other data pipeline job function(s) and/or settings from the data pipeline job configuration and enables the data pipeline job function(s) and settings with the data source requests to the data source. For example, the data transformation system 106, as part of a data pipeline job, can identify instructions, within the data pipeline job configuration to execute one or more data pipeline job functions and/or settings while executing the data source requests for the data source. To illustrate, the data transformation system 106 can cause a data source (via the generated native code commands) read and/or write data on the data source (e.g., to move or transform the data) while also performing other functions or configuring settings in relation to the data, such as, but not limited to, utilizing tags, utilizing parameters, setting and/or using permissions and/or roles, monitoring the data and/or the data pipeline job, generating alerts, watermarking, and/or scheduling.

As shown in FIG. 4, the data transformation system 106 can identify tags 404 from the data pipeline job configuration 402. In particular, the data transformation system 106 can utilize the tags 404 to classify a data pipeline job within a data transformation framework and/or a data source. In some cases, a tag can include a team identifier, a department identifier, an owner, and/or group owner for a particular data pipeline job configuration. In some cases, the data transformation system 106 utilizes the tags to organize data pipeline jobs and/or to specify an executing entity for the data source. In some cases, the data transformation system 106 utilizes tags to determine where to write data from a data source (e.g., a target repository and/or file).

Furthermore, as shown in FIG. 4, the data transformation system 106 can identify parameters 408 from the data pipeline job configuration 402. For example, the data transformation system 106 can utilize the parameters 408 to set or configure various aspects of a data pipeline job, such as, but not limited to, file mappings, metadata, schema settings, file sizes, data size, data storage partitions, data types (e.g., float, string, integer) for data, and/or max run times. In some cases, the parameters can include a specification of a data pipeline job type (e.g., input type and/or output type) to indicate whether the data pipeline job will input data (e.g., access or read data) and/or output data (e.g., write data to a data source).

In addition, as shown in FIG. 4, the data transformation system 106 can identify permissions 410 from the data pipeline job configuration 402. For instance, the data transformation system 106 can utilize the permissions 410 to determine access rights of users, permitted users for the data pipeline job, roles for access to data sources, and/or authentication (or credentials) to access data sources. Indeed, the data transformation system 106 utilizes the permissions 410 to determine access to particular data from data sources and/or access to the data pipeline job and/or transformation framework. In some cases, the data transformation system 106 utilizes the permissions 410 to determine access to particular data such as personal information (PI) data.

Moreover, as shown in FIG. 4, the data transformation system 106 can identify monitoring and/or alerting request(s) 414 from the data pipeline job configuration 402. In particular, the data transformation system 106 can identify requests to monitor various aspects of the data pipeline job (e.g., monitoring the collection of data, the access to data sources, the transformation of data, the movement of data). In some cases, the data transformation system 106 can also identify requests to monitor statistics of the data pipeline job as described below (e.g., in relation to FIG. 6).

In certain embodiments, the data transformation system 106 identifies requests to generate and/or transmit alerts (e.g., as electronic messages, push notifications, emails) upon identifying particular information within a data pipeline job. For example, the data transformation system 106 can identify a request to transmit an alert upon a data pipeline job failing. In some cases, the data transformation system 106 identifies a request to transmit an alert upon detecting a failed connection with a data source.

As further shown in FIG. 4, the data transformation system 106 can identify watermarking request(s) 416 from the data pipeline job configuration 402. In particular, the data transformation system 106 can identify watermarking requests that track data within the data pipeline (e.g., input and/or output data) to determine the age (or lag) of the data. For example, the data transformation system 106 can identify watermarking requests that utilize watermarking thresholds and timestamps to create windows of data arrival times and to mark data as late when it is received and/or transmitted after the watermarking threshold (or window of arrival time).

As also shown in FIG. 4, the data transformation system 106 can identify information or instructions for scheduling 418 from the data pipeline job configuration 402. For example, the data transformation system 106 can identify a job schedule for the data pipeline job. Indeed, in one or more embodiments, the data transformation system 106 identifies a job schedule for the data pipeline job that indicates run times for the data pipeline job, such as, but not limited to, a frequency of executing the data pipeline job, a date of execution, and/or a time of execution.

Although FIG. 4 illustrates various data pipeline job functions that the data transformation system 106 can execute in addition to the data source requests using the data source connectors, the data transformation system 106 can include other data pipeline functions. For example, the data transformation system 106 can also include other data pipeline functions, such as, but not limited to unit testing, logging, fault tolerance settings, zero downtime settings, checking point settings, versioning, building reports, data pre-load checks, business validation of data, configuring security controls on data, and/or seamless code deployment through the data pipeline job configuration. Additionally, the data transformation system 106 can utilize a data pipeline job configuration to identify and/or execute various combinations of the data pipeline job requests and/or functions (as described above).

As further shown in FIG. 4, the data transformation system 106 can, in some implementations, identify an additional data identifier 420 and additional data source request(s) 422 from the data pipeline job configuration 402. Indeed, the data transformation system 106 can utilize the additional data identifier 420 to select an additional data source connector to convert the additional data source request(s) 422 to native code commands for an additional data source. Then, the data transformation system 106 can utilize the native code commands from the additional data source request(s) 422 to read and/or write data in relation to the additional data source. As an example, the data transformation system 106 can identify multiple data source identifiers and/or requests for the multiple data sources to execute a data pipeline job that as an input data source (where input data is accessed) and a target data source (where data is output to or stored on). In one or more embodiments, the data transformation system 106 can utilize a data pipeline job configuration having requests for various numbers of data sources (e.g., as target data sources and/or input data sources.

Additionally, FIGS. 5A and 5B illustrate exemplary data pipeline job configurations that include data source identifiers and data source requests that the data transformation system 106 can convert to native code commands for a data source using a data source connector. For example, FIG. 5A illustrates a data pipeline job configuration 502 (e.g., as executable code). As shown in FIG. 5A, the data transformation system 106 can identify a data source identifier 504 within the data pipeline job configuration 502 (e.g., “datasource 1”) which can be utilized to select a connector and convert the data source requests 510 to native code commands for the data source (e.g., data source 1) in accordance with one or more implementations herein. Moreover, as shown in FIG. 5A, the data transformation system 106 can identify a data pipeline job configuration type 506 (e.g., indicating that the data source requests are for data input to the data pipeline). Moreover, as shown in FIG. 5A, the data transformation system 106 can identify a file indicator 508 for the data pipeline (e.g., to input and/or output data to a particular file for the data source requests 510 for logging the data pipeline functions and/or the data movement).

As shown in FIG. 5A, the data transformation system 106 can identify the data source requests 510 in the data pipeline job configuration 502. As shown in FIG. 5A, the data source requests 510 are represented as instructions in a programming language (e.g., a database query). In some cases, the data transformation system 106 utilizes the data source requests 510 and utilizes a data source connector—as described above—to generate native code commands that are recognized on the particular data source. Indeed, in one or more embodiments, the data transformation system 106 can identify data source requests in a common (or singular) programming language (e.g., like the database query language of the data source requests 510) regardless of a programming language utilized by the data source.

Furthermore, FIG. 5B illustrates an example of the data transformation system 106 identifying a data pipeline job configuration 512 with data source requests for a data pipeline output task. For example, as shown in FIG. 5B, the data transformation system 106 can identify a data source identifier 514 within the data pipeline job configuration 512 (e.g., “datasource2”) which can be utilized to select a connector and convert the data source requests 520 to native code commands for the data source (e.g., data source 2) in accordance with one or more implementations herein. Additionally, as shown in FIG. 5B, the data transformation system 106 can identify a data pipeline job configuration type 516 (e.g., indicating that the data source requests are for data output from the data pipeline). As further shown in FIG. 5B, the data transformation system 106 can identify a file indicator 518 for the data pipeline (e.g., to input and/or output data to a particular file for the data source requests 520 for logging the data pipeline functions and/or the data movement).

As mentioned above, in one or more embodiments, the data transformation system 106 monitoring a data pipeline job executed through a data pipeline job configuration having data source identifiers (for data source connectors). For example, FIG. 6 illustrates the data transformation system 106 monitoring activity and displaying the activity of one or more data pipeline jobs (executed in accordance with one or more embodiments herein). Indeed, FIG. 6 illustrates the data transformation system 106 monitoring activity in accordance with one or more monitoring requests within a data pipeline job configuration.

As shown in FIG. 6, the data transformation system 106 can, upon executing a data pipeline job configuration 602 for a data source 608 via a transformation framework 604, provide, for display within a graphical user interface 612 of an administrator device 610, information from monitored activity of one or more data pipeline jobs. For example, as shown in FIG. 6, the data transformation system 106 can determine and display the number of data pipeline jobs executed, the average execution time of the data pipeline jobs, data pipeline job successes and failures, and a number of errors during execution of a data pipeline job. Furthermore, as shown in FIG. 6, the data transformation system 106 can also provide for display, a selectable element (e.g., “See Errors Log”) to view an error log for the one or more data pipeline jobs. Indeed, the error log can include error messages and one or more debugging features for one or more data pipeline job configurations and/or data pipeline jobs monitored by the data transformation system 106.

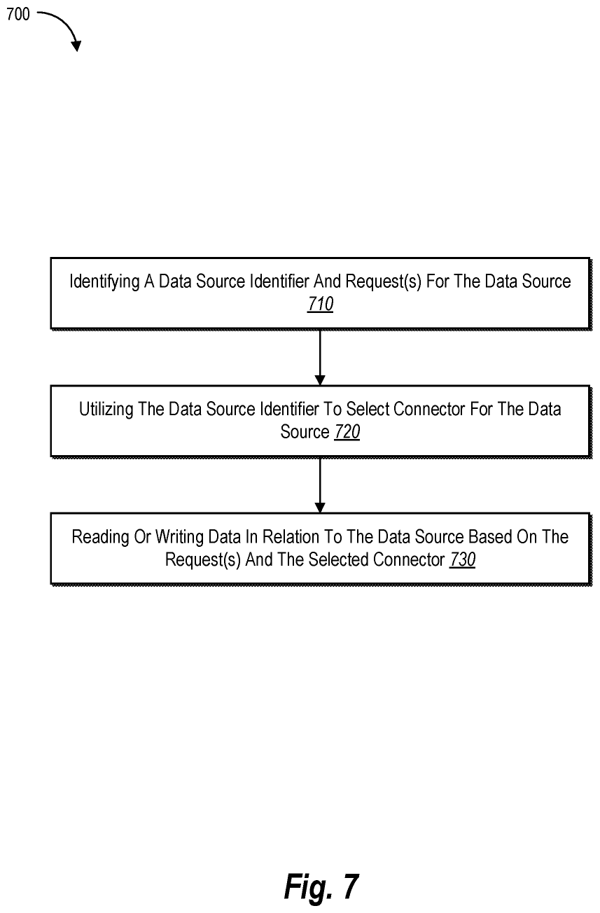

Turning now to FIG. 7, this figure shows a flowchart of a series of acts 700 for utilizing a data pipeline job configuration to convert requests to native code commands of a data source to read and/or write data in relation to the data source in accordance with one or more implementations. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable storage medium can comprise instructions that, when executed by the one or more processors, cause a computing device to perform the acts depicted in FIG. 7. In still further embodiments, a system can perform the acts of FIG. 7.

As shown in FIG. 7, the series of acts 700 include an act 710 of identifying a data source identifier and request(s) for the data source. For example, the act 710 can include identifying, from a data pipeline job configuration, an identifier for a data source and one or more requests for the data source. Furthermore, the act 710 can include identifying, from a data pipeline job configuration, an additional identifier for a target data source and an additional one or more requests.

For instance, a data pipeline job configuration can include one or more tags for a connector of a data source, scheduling settings, monitoring requests, alerting requests, watermarking requests, access permission settings, or output file identifiers. In addition, an identifier for a data source can indicate selection or name of the data source. Furthermore, the act 710 can further include identifying a data source request type (e.g., an input request or an output request). Furthermore, in some cases, one or more requests can be in a programming language that is different from an additional programming language recognized by a computer network of the data source. In certain instances, one or more requests can be one or more graphical user interface selectable options.

As also shown in FIG. 7, the series of acts 700 include an act 720 of utilizing the data source identifier to select a connector for the data source. For instance, the act 720 can include utilizing an identifier for a data source to select a connector for the data source. Additionally, the act 720 can include selecting an additional connector utilizing an additional identifier for a target data source.

As shown in FIG. 7, the series of acts 700 include an act 730 of reading or writing data in relation to the data source based on the request(s) and the selected connector. For example, the act 730 can include reading or writing data in relation to a data source based on one or more requests by mapping the one or more requests to native code commands for a data source through a connector. In some cases, the act 730 can include reading data from an input data source utilizing native code commands determined from one or more requests and writing the data from the input data source to a target data source identified from a data pipeline job configuration. In one or more implementations, the act 730 includes mapping one or more requests to native code commands for a data source through a connector by converting the one or more requests to a programming language recognized by a computer network of the data source.

In some instances, the act 730 can include modifying data from an input data source utilizing native code commands determined from one or more requests. In one or more implementations, the act 730 includes writing data, identified from a data pipeline job configuration, to a target data source using native code commands determined from one or more requests. Additionally, the act 730 can include writing data to a target data source based on an additional one or more requests by mapping the additional one or more requests to additional native code commands for a target data source through an additional connector.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RANI and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 that may be configured to perform one or more of the processes described above. One will appreciate that the data transformation system 106 (or the inter-network facilitation system 104) can comprise implementations of a computing device, including, but not limited to, the devices or systems illustrated in the previous figures. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output (“I/O”) interface 808, which are provided to allow a user (e.g., requester or provider) to provide input to (such as user strokes), receive output from, and otherwise transfer data to and from the computing device 800. These I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that couples components of computing device 800 to each other.

FIG. 9 illustrates an example network environment 900 of the inter-network facilitation system 104. The network environment 900 includes a client device 906 (e.g., client devices 112a-112n and/or an administrator device 116), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation systems 104, third-party systems 908, and networks 904, this disclosure contemplates any suitable number of client devices 906, inter-network facilitation system 104, third-party systems 908, and networks 904. As an example, and not by way of limitation, network environment 900 may include multiple client devices 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, inter-network facilitation system 104 (e.g., which hosts the data transformation system 106), and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party-system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying, from a data pipeline job configuration, an identifier for a data source and one or more requests for the data source;
utilizing the identifier for the data source to select a connector for the data source; and
reading or writing data in relation to the data source based on the one or more requests by mapping the one or more requests to native code commands for the data source through the connector.

2. The computer-implemented method of claim 1, wherein the data source comprises an input data source and further comprising:
reading the data from the data source utilizing the native code commands determined from the one or more requests; and
writing the data from the data source to a target data source identified from the data pipeline job configuration.

3. The computer-implemented method of claim 2, further comprising:
identifying, from the data pipeline job configuration, an additional identifier for the target data source and an additional one or more requests;
selecting an additional connector utilizing the additional identifier for the target data source; and
writing the data to the target data source based on the additional one or more requests by mapping the additional one or more requests to additional native code commands for the target data source through the additional connector.

4. The computer-implemented method of claim 2, further comprising modifying the data from the input data source utilizing the native code commands determined from the one or more requests.

5. The computer-implemented method of claim 1, wherein the data source comprises a target data source and further comprising writing the data, identified from the data pipeline job configuration, to the target data source using the native code commands determined from the one or more requests.

6. The computer-implemented method of claim 1, wherein the data pipeline job configuration comprises one or more tags for the connector of the data source, scheduling settings, monitoring requests, alerting requests, watermarking requests, access permission settings, or output file identifiers.

7. The computer-implemented method of claim 1, wherein the identifier for a data source indicates a selection or name of the data source and further comprising identifying a data source request type, wherein the data source request type comprises an input request or an output request.

8. The computer-implemented method of claim 1, further comprising mapping the one or more requests to the native code commands for the data source through the connector by converting the one or more requests to a programming language recognized by a computer network of the data source.

9. The computer-implemented method of claim 1, wherein:
the one or more requests comprise a programming language that is different from an additional programming language recognized by a computer network of the data source; or
the one or more requests comprise one or more graphical user interface selectable options.

10. A non-transitory computer-readable medium storing instructions that, when executed by at least one processor, cause a computing device to:
identify, from a data pipeline job configuration, an identifier for a data source and one or more requests for the data source;
utilize the identifier for the data source to select a connector for the data source; and
read or write data in relation to the data source based on the one or more requests by mapping the one or more requests to native code commands for the data source through the connector.

11. The non-transitory computer-readable medium of claim 10, further comprising instructions that, when executed by the at least one processor, cause the computing device to:
read the data from the data source utilizing the native code commands determined from the one or more requests; and
write the data from the data source to a target data source identified from the data pipeline job configuration.

12. The non-transitory computer-readable medium of claim 11, further comprising instructions that, when executed by the at least one processor, cause the computing device to:
identify, from the data pipeline job configuration, an additional identifier for the target data source and an additional one or more requests;
select an additional connector utilizing the additional identifier for the target data source; and
write the data to the target data source based on the additional one or more requests by mapping the additional one or more requests to additional native code commands for the target data source through the additional connector.

13. The non-transitory computer-readable medium of claim 11, further comprising instructions that, when executed by the at least one processor, cause the computing device to modify the data from the data source utilizing the native code commands determined from the one or more requests.

14. The non-transitory computer-readable medium of claim 10, wherein the data source comprises a target data source and further comprising writing the data, identified from the data pipeline job configuration, to the target data source using the native code commands determined from the one or more requests.

15. The non-transitory computer-readable medium of claim 10, further comprising instructions that, when executed by the at least one processor, cause the computing device to map the one or more requests to the native code commands for the data source through the connector by converting the one or more requests to a programming language recognized by a computer network of the data source.

16. A system comprising:
at least one processor; and
at least one non-transitory computer-readable storage medium storing instructions that, when executed by the at least one processor, cause the system to:
identify, from a data pipeline job configuration, an identifier for a data source and one or more requests for the data source;
utilize the identifier for the data source to select a connector for the data source; and
read or write data in relation to the data source based on the one or more requests by mapping the one or more requests to native code commands for the data source through the connector.

17. The system of claim 16, further comprising instructions that, when executed by the at least one processor, cause the system to:
read the data from the data source utilizing the native code commands determined from the one or more requests; and
write the data from the data source to a target data source identified from the data pipeline job configuration.

18. The system of claim 16, wherein the data source comprises a target data source and further comprising writing the data, identified from the data pipeline job configuration, to the target data source using the native code commands determined from the one or more requests.

19. The system of claim 16, further comprising instructions that, when executed by the at least one processor, cause the system to map the one or more requests to the native code commands for the data source through the connector by converting the one or more requests to a programming language recognized by a computer network of the data source.

20. The system of claim 16, wherein:
the one or more requests comprise a programming language that is different from an additional programming language recognized by a computer network of the data source; or
the one or more requests comprise one or more graphical user interface selectable options.
